(19) United States
(12) Patent Application Publication
(10) Pub. No.: US 2026/0054389 A1
(43) Pub. Date: Feb. 26, 2026

(54) MANUFACTURING SYSTEM, CONTROL METHOD, AND COMPUTER-READABLE MEDIUM STORING CONTROL PROGRAM

(71) Applicant: LINKWIZ INCORPORATED, Chuo-ku Hamamatsu-shi, Shizuoka (JP)

(72) Inventors: Motofumi SUZUKI, Hamamatsu-shi, Shizuoka (JP); Shuichi SHIMOYAMA, Hamamatsu-shi, Shizuoka (JP)

(21) Appl. No.: 19/103,448

(22) PCT Filed: Aug. 24, 2023
(86) PCT No.: PCT/JP2023/030612

§ 371 Date: Feb. 12, 2025

(30) Foreign Application Priority Data
Aug. 29, 2022 (JP) 2022-136035
Aug. 29, 2022 (JP) 2022-136036

(51) Int. Cl. B25J 9/16; G01B 11/24

(52) U.S. Cl. CPC B25J 9/1687; G01B 11/24

(57) ABSTRACT

A manufacturing system according to an aspect of the present disclosure includes: at least one measurement sensor configured to measure a shape of each of a plurality of components an assembling target component group selection unit configured to select, from among the plurality of components, a first assembling target component group including at least two components, the at least two components being components of the assembly; an assembling state estimation unit configured to estimate an assembling state of the assembly based on the shape data of the components belonging to the first assembling target component group; and an assembling execution command unit configured to provide, to to an assembling robot, an assembling execution command for instructing the assembling robot to assemble the assembly using the components included in the first assembling target component group based on a result of the estimation by the assembling state estimation unit.

### CROSS REFERENCE TO RELATED APPLICATIONS

The present application is a U.S. National Phase of International Application No. PCT/JP2023/030612 entitled “MANUFACTURING SYSTEM, CONTROL METHOD, AND CONTROL PROGRAM,” and filed on Aug. 24, 2023. International Application No. PCT/JP2023/030612 claims priority to Japanese Patent Application No. 2022-136035 filed on Aug. 29, 2022, and Japanese Patent Application No. 2022-136036 filed on Aug. 29, 2022. The entire contents of each of the above-listed applications are hereby incorporated by reference for all purposes.

### TECHNICAL FIELD

The present invention relates to a technology for performing work such as assembling of a plurality of components by welding.

### BACKGROUND ART

A technology for generating a welding operation to be performed by a welding robot based on a result of measurement of a member to be welded has been proposed. In particular, Patent Literature 1 discloses a technology for generating a 3D (three-dimensional) model from 3D point group data of a member to be welded obtained by a 3D measurement sensor and generating, i.e., performing, a welding operation based on the generated 3D model.

### CITATION LIST

### Patent Literature

Patent Literature 1: Japanese Patent. No. 6985464

### SUMMARY

There has been a problem that in the case where an assembly, e.g., an intermediate or final product formed by assembling a plurality of components, is manufactured by assembling a plurality of components by welding, bolting, or the like, even when the dimensional error of each of the components is within a tolerance range, an assembly whose shape errors do not fall within the permissible range occur at a certain rate because the tolerance matching of components to be assembled is unsatisfactory.

An aspect of the present invention is a manufacturing system including: at least one measurement sensor configured to measure a shape of each of a plurality of components of which an assembly is formed; a shape data storage unit configured to store shape data of each of the components acquired by the measurement sensor; an assembling target component group selection unit configured to select, from among the plurality of components, a first assembling target component group including at least two components, the at least two components being components of the assembly; an assembling state estimation unit configured to estimate an assembling state of the assembly based on the shape data of the components belonging to the first assembling target component group; and an assembling execution command unit configured to provide, to an assembling robot, an assembling execution command for instructing the assembling robot to assemble the assembly using the components included in the first assembling target component group based on a result of the estimation by the assembling state estimation unit.

An aspect of the present invention is a method for controlling a manufacturing system configured to manufacture an assembly by assembling a plurality of components by using an assembling robot, in which a computer performs processes including: acquiring, for each of a plurality of components of which the assembly is formed, shape data of the component from a result of measurement of a shape of the component; storing the shape data of each of the components in a shape data storage unit; selecting, from among the plurality of components, a first assembling target component group including at least two components, the at least two components being components of the assembly; estimating an assembling state of the assembly based on the shape data of the components belonging to the first assembling target component group; and providing, to an assembling robot, an assembling execution command for instructing the assembling robot to assemble the assembly using the components included in the first assembling target component group based on a result of the estimation.

An aspect of the present invention is a computer-readable medium storing a control program for causing a computer to perform processes including: a shape data acquisition process for acquiring, for each of a plurality of components of which the assembly is formed, shape data of the component from a result of measurement of a shape of the component; a shape data storing process for storing the shape data of each of the components in a shape data storage unit; an assembling target component group selecting process for selecting, from among the plurality of components, a first assembling target component group including at least two components, the at least two components being components of the assembly; an assembling state estimation process for estimating an assembling state of the assembly based on the shape data of the components belonging to the first assembling target component group; and an assembling execution command for providing, to an assembling robot, an assembling execution command for instructing the assembling robot to assemble the assembly using the components included in the first assembling target component group based on a result of the estimation.

Other problems to be solved and their solutions disclosed in the present application will be clarified by descriptions of embodiments according to the invention and drawings thereof.

According to the present invention, it is possible to provide a manufacturing system and a manufacturing method in which selecting of components from which an apparatus is assembled so that its shape error falls within a permissible range can be performed more efficiently.

### BRIEF DESCRIPTION OF DRAWINGS

FIG. 1 shows an example of an overall configuration of a manufacturing system 1000 according to an embodiment;

FIG. 2 shows an example of a hardware configuration of a measurement robot according to an embodiment;

FIG. 3 shows an example of a hardware configuration of an assembling robot according to an embodiment;

FIG. 4 shows an example of a hardware configuration when a measurement robot and an assembling robot are implemented by a common general-purpose robot according to this embodiment;

FIG. 5 shows an example of a hardware configuration of a cooperation control unit and the like according to an embodiment;

FIG. 6 shows an example of a functional configuration of a measurement control unit 2400 according to an embodiment;

FIG. 7 shows an example of a functional configuration of a cooperation control unit 2500 according to an embodiment;

FIG. 8 shows an example of a functional configuration of an assembling control unit 2600 according to an embodiment;

FIG. 9 shows an example of a manufacturing process using a manufacturing system according to an embodiment;

FIG. 10 shows an example of an overall operation flow of a manufacturing system according to an embodiment;

FIG. 11 shows another example of an overall operation flow of a manufacturing system according to an embodiment;

FIG. 12 shows an example of an apparatus manufactured by a manufacturing system according to an embodiment;

FIG. 13 shows an assembling error that occurs in an apparatus manufactured by a manufacturing system according to an embodiment; and

FIG. 14 shows an assembling error that occurs in an apparatus manufactured by a manufacturing system according to an embodiment.

### DESCRIPTION OF EMBODIMENTS

### Details of First Embodiment

Specific examples of a manufacturing system 1000 according to an embodiment of the present invention will be described hereinafter with reference to the drawings. Note that the present invention is not limited to these examples, but is represented by the scope of the claims. Further, all modifications within the meaning and scope equivalent to those of the scope of the claims are included in the invention. The same or similar elements are assigned the same or similar reference numerals (or symbols) and the same or similar names in the following description and the accompanying drawings. Further, redundant descriptions of the same or similar elements may be omitted as appropriate in the descriptions of embodiments. Further, features shown in one embodiment can be applied to other embodiments as long as they do not contradict features in the other embodiments.

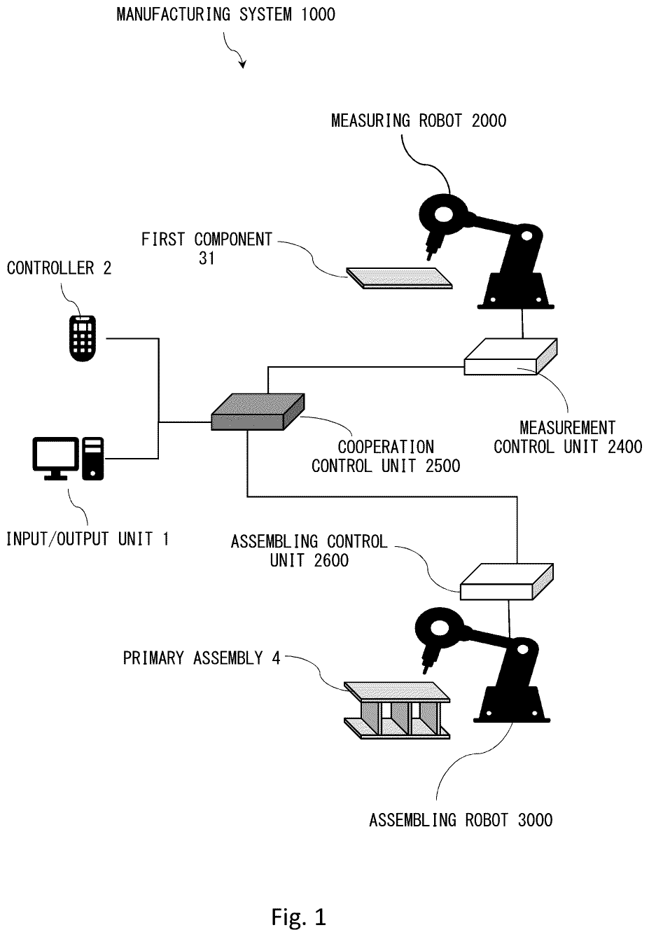

FIG. 1 shows an example of a manufacturing system 1000 according to an embodiment. As shown in FIG. 1, the manufacturing system 1000 according to this embodiment includes an assembling robot 3000 that performs work for assembling a first assembling target component group according to an assembling execution command output from an assembling execution command unit 2519.

More specifically, as shown in FIG. 1, the manufacturing system 1000 according to this embodiment includes an input/output unit 1, a controller 2, one or a plurality of measuring robots 2000, one or a plurality of measurement control units 2400, a cooperation control unit 2500, one or a plurality of assembling control units 2600, and one or a plurality of assembling robots 3000. The measuring robot 2000 acquires information about the shape of a first component 41 to be measured by using a measurement sensor 22. The measurement control unit 2400 is a control unit that is connected to the measuring robot 2000 through a wire or wirelessly so that they can communicate with each other, controls a measuring operation performed by the measurement sensor 22 mounted on the measuring robot 2000 and an operation performed by an arm 21 of the measuring robot, and acquires a result of the measurement. Regarding the measurement control unit 2400, when there are a plurality of measuring robots 2000, a plurality of measurement control units 2400 may be respectively provided for these measuring robots. The cooperation control unit 2500 is a control unit that is connected to each of the measurement control units 2400 through a wire or wirelessly so that they can communicate with each other, and it estimates the shape of a primary assembly that is formed by assembling the first component 41 to be measured and a second component to be assembled to the first component based on information about measurement results respectively acquired from the measurement control units 2400. Note that the cooperation control unit 2500 does not necessarily have to be an apparatus independent of the measurement control unit 2400. That is, both the cooperation control unit 2500 and the measurement control unit 2400 may be implemented by one apparatus.

The input/output unit 1 is connected to the cooperation control unit 2500 through a wire or wirelessly so that they can communicate with each other, and includes an output device (e.g., a display device) that displays data stored in each storage unit of the cooperation control unit 2500 and also includes an information input device (e.g., a keyboard, a mouse, or a touch panel) that receives and updates data and the like stored in each storage unit. The controller 2 is connected to the cooperation control unit 2500 through a wire or wirelessly so that they can communicate with each other, and includes an input unit that receives instructions for starting and stopping operations performed by the measurement sensor 22 and the arm 21 of the measuring robot 2000.

The assembling control unit 2600 is connected to the cooperation control unit 2500 through a wire or wirelessly so that they can communicate with each other, and receives an assembling execution command from the cooperation control unit 2500. Further, the assembling control unit 2600 is also connected to the assembling robot 3000 through a wire or wirelessly so that they can communicate with each other. When the assembling control unit 2600 receives an assembling execution command from the cooperation control unit 2500, it performs assembling work by controlling the operation performed by a welding torch 32 and an arm 31 mounted on the assembling robot 3000 based on the received assembling execution command.

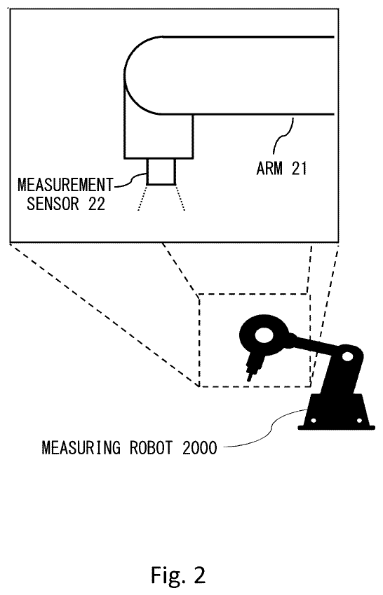

FIG. 2 shows an example of a hardware configuration of the measuring robot 2000. As shown in FIG. 2, the measuring robot 2000 includes an arm 21, and a measurement sensor 22 is mounted on the arm 21. The measuring robot 2000 acquires 3D point group data of the first component 41 to be measured by controlling the position and orientation of the measurement sensor 22 based on a command signal for the position and orientation of the measurement sensor 22 which the measurement control unit generates according to 3D CAD data of the first component 41 recorded in advance in a 3D CAD data storage unit 2521 of the cooperation control unit 2500.

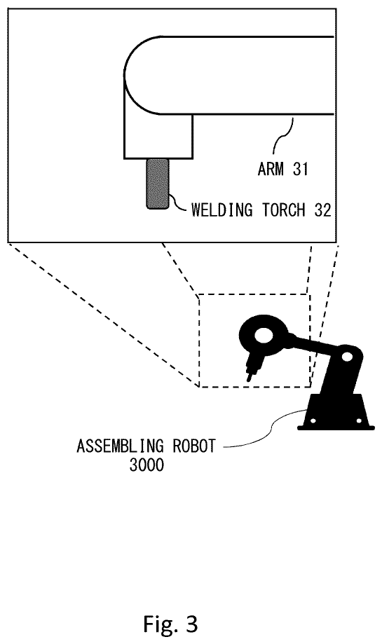

FIG. 3 shows an example of a hardware configuration of the assembling robot 3000. As shown in FIG. 3, the assembling robot 3000 includes an arm 31, and a welding torch 32 is mounted on the arm 31. Note that the tool or the like mounted on the arm 31 does not necessarily have to be the welding torch. That is, when components are assembled by fastening bolts, a spanner for fastening bolts, instead of the welding torch, may be mounted on the arm 31, and when components are assembled by screws, a screwdriver for fastening screws, instead of the welding torch, may be mounted on the arm 31. When an assembling execution command is output from the cooperation control unit 2500, the assembling robot 3000 performs work for assembling a plurality of components selected by an assembling target component group selection unit 2514.

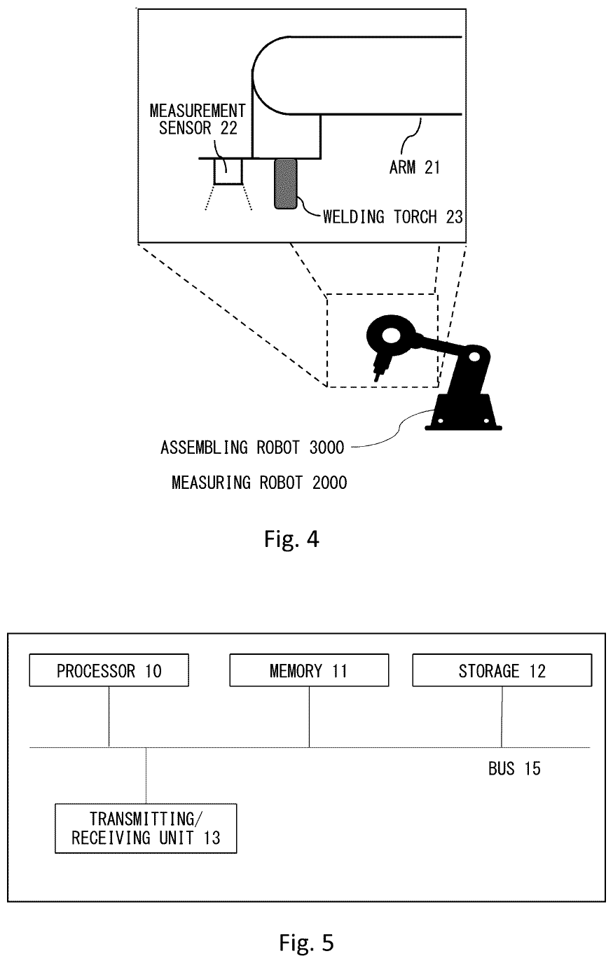

FIG. 4 shows an example of a hardware configuration in the case where a measuring robot and an assembling robot are implemented by a common general-purpose robot. Although FIGS. 2 and 3 show examples of a measuring robot specialized in measuring work and an assembling robot specialized in assembling work, the present invention is not limited to such examples. As shown in FIG. 4, it is also possible to perform operations performed by a measuring robot and an assembling robot by using a general-purpose robot in which both a measurement sensor 22 and a welding torch 23 are mounted on its arm 21.

### Hardware

FIG. 5 shows a hardware configuration for the measurement control unit 2400, the cooperation control unit 2500, and the assembling control unit 2600. The measurement control unit 2400, the cooperation control unit 2500, and the assembling control unit 2600 may be a general-purpose computer such as a personal computer, or may be logically implemented by a cloud computing system. Note that the configuration shown in the drawing is just an example, and they may have other configurations. For example, some of the functions provided in the processor 10 may be performed by a server or a separate terminal disposed outside the measurement control unit 2400, the cooperation control unit 2500, and the assembling control unit 2600.

The measurement control unit 2400, the cooperation control unit 2500, and the assembling control unit 2600 include at least a processor 10, a memory 11, a storage 12, a transmitting/receiving unit 13, and the like, which are electrically connected to each other through a bus 15.

The processor 10 is an arithmetic apparatus that controls the operations performed by the control unit (measurement control unit 2400, cooperation control unit 2500, and assembling control unit 2600) in which the processor 10 itself is installed, controls transmission/reception of data and the like with an apparatus connected thereto by a wire or wireless through the transmitting/receiving unit 13, and performs information processing and the like necessary for the execution of an application and an authentication process. For example, the processor 10 is a CPU (Central Processing Unit) or a GPU (Graphics Processing Unit), or is a combination of a CPU and a GPU. Further, the processor 10 performs various information processes by executing a program(s) or the like for the system which is stored in the storage 12 and loaded onto the memory 11.

The memory 11 includes a main memory composed of a volatile storage device such as a DRAM (Dynamic Random Access Memory) and an auxiliary memory composed of a non-volatile storage device such as a flash memory or an HDD (Hard Disc Drive). The memory 11 is used as a work area and the like for the processor 10. Further, a BIOS (Basic Input/Output System) that is executed when the control unit (measurement control unit 2400, cooperation control unit 2500, and assembling control unit 2600) in which the memory 11 itself is installed is started up as well as other various setting information items and the like are stored in the memory 11.

Various programs such as application programs are stored in the storage 12. A database in which data used for various processes are stored may be constructed in the storage 12.

The transmitting/receiving unit 13 is connected to another apparatus that is connected to the control unit in which the transmitting/receiving unit 13 itself is installed so that they can communicate with each other, and transmits/receives data and the like according to an instruction from the processor. Note that the transmitting/receiving unit 13 may be configured by a wire(s) or wirelessly. When the transmitting/receiving unit 13 is wirelessly configured, it may be configured by, for example, a short-range communication interface such as WiFi, Bluetooth (Registered Trademark), or BLE (Bluetooth Low Energy).

The common bus 15 is connected to each of the above-described components, and for example, address signals, data signals, and various control signals are transmitted through the bus 15.

### Measuring Operation

A measuring operation performed by the measuring robot 2000 or a general-purpose robot according to this embodiment will be described by referring to FIGS. 1, 2 and 4 again. As described above, the measuring robot 2000 includes the arm 21 and the measurement sensor 22. Note that the configuration shown in the drawing is merely an example, and the configuration of the measuring robot 2000 is not limited to this configuration. The operation of the arm 21 is controlled by the measurement control unit 2400 based on a 3D robot coordinate system.

The measurement sensor 22 measures a first component 41 based on a 3D sensor coordinate system. The measurement sensor 22 is, for example, a laser sensor that operates as a 3D scanner and acquires 3D point group data of the first component 41 through the measurement thereof. In the 3D point group data, for example, each point data has coordinate information in the sensor coordinate system, thus making it possible to find out the shape of the first component 41 based on the point group. Note that the measurement sensor 22 is not limited to the laser sensor, but may be, for example, an image sensor using a stereo system or the like, or may be a sensor independent of the measuring robot 2000. That is, the measurement sensor 22 may be any type of sensor as long as it can acquire coordinate information in the 3D sensor coordinate system.

Note that the robot coordinate system and the sensor coordinate system may be associated with each other by performing a predetermined calibration before the work. Then, for example, a user may designate a position (coordinates) based on the sensor coordinate system so that the operations of the arm 21 and the measurement sensor 22 are controlled based on the corresponding position. Further, in the case where the shape of the first component 41 is complicated, the 3D point group data of the first component 41 is acquired by performing measuring operations a plurality of times by using a plurality of measuring robots 2000 or by changing the posture of the measuring robot 2000. Then, the cooperation control unit 2500 performs a process such as a determination whether or not the first component 41 is suitable or whether or not to permit the first component 41 to be assembled based on the acquired 3D point group data. Note that by defining the coordinates of a plurality of measuring robots in the same coordinate system, 3D point group data acquired by these measuring robots can be integrated in a short time, so that the integrated 3D point group data of the whole component(s) to be assembled can be accurately obtained in a short time. Further, since the 3D point group data acquired by the plurality of the measuring robots 2000 or by the plurality of times of measuring operations are integrated by the cooperation control unit 2500, i.e., since the above-described integration process is performed, the measurement range of the 3D point group data acquired by the plurality of the measuring robots 2000 or by the plurality of times of measuring operations is defined in such a manner that measured positions overlap each other.

### Assembling Operation

An assembling operation performed by the assembling robot 3000 or the general-purpose robot according to this embodiment will be described with reference to FIGS. 1, 3 and 4. As described above, the assembling robot 3000 or the general-purpose robot includes an arm 31 and a welding torch 32. Note that the configuration shown in the drawing is merely an example, and the configuration of the assembling robot 3000 is not limited to this configuration.

The welding torch 32 performs work for assembling the first component 41 based on a 3D torch coordinate system. The welding torch 32 is a tool used, for example, in a welding method using fusion welding such as arc welding, laser welding, electron beam welding, and plasma arc welding, and assembles the assembling target component group including the first component by outputting an arc, laser, or beam for melting the target component from the welding torch. Note that the welding torch may be a discharging unit for discharging a filler metal (adhesive) used in brazing welding such as brazing, or a discharging unit for discharging a sealing material or adhesive. When components are assembled by fastening bolts, a spanner for fastening bolts, instead of the welding torch, may be used, and when components are assembled by screws, a screwdriver for fastening screws, instead of the welding torch, may be used.

Note that the assembling robot 3000 and the torch coordinate system may be associated with each other by performing a predetermined calibration before the work. Then, for example, a user may designate a position (coordinates) based on the torch coordinate system so that the operations of the arm 31 and the welding torch 32 are controlled based on the corresponding position. Further, when the assembling work is performed by using a plurality of assembling robots, it is possible to distribute the assembling work to these assembling robots in a short time by defining the coordinates of these assembling robots in the same robot coordinate system.

### Function of Measurement Control Unit 2400

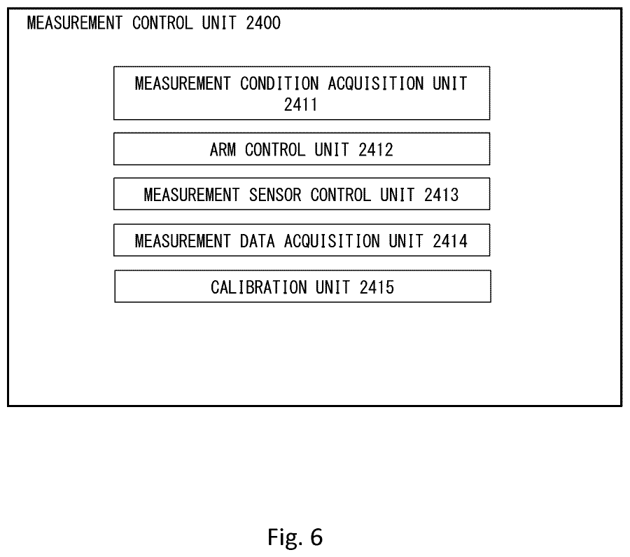

FIG. 6 shows an example of a functional configuration of the measurement control unit 2400. The measurement control unit 2400 includes a measurement condition acquisition unit 2411, an arm control unit 2412, a measurement sensor control unit 2413, a measurement data acquisition unit 2414, and a calibration unit 2415. The measurement condition acquisition unit 2411 receives measurement condition information about a measuring operation (information including the position and measurement direction of the measurement sensor 22) from the cooperation control unit 2500. The arm control unit 2412 generates an operation command for the arm 21 that satisfies the measurement condition, and transmits this operation command to the measuring robot 2000 which is connected to the arm control unit 2412 so that they can communicate with each other. By doing so, the arm control unit 2412 controls the arm of the measuring robot 2000. Further, the measurement sensor control unit 2413 generates an operation command for the measurement sensor 22 that satisfies the measurement condition, and transmits this operation command to the measurement sensor 22 mounted on the measuring robot 2000 which is connected to the measurement sensor control unit 2413 so that they can communicate with each other. By doing so, the measurement sensor control unit 2413 controls the measurement sensor 22.

The measurement data acquisition unit 2414 acquires 3D point group data of the first component 41 measured by the measurement sensor. Further, the measurement data acquisition unit 2414 transmits the acquired 3D point group data to the cooperation control unit 2500. The calibration unit 2415 associates the robot coordinate system and the sensor coordinate system with each other by performing a predetermined calibration before the work.

### Functions of Cooperation Control Unit 2500

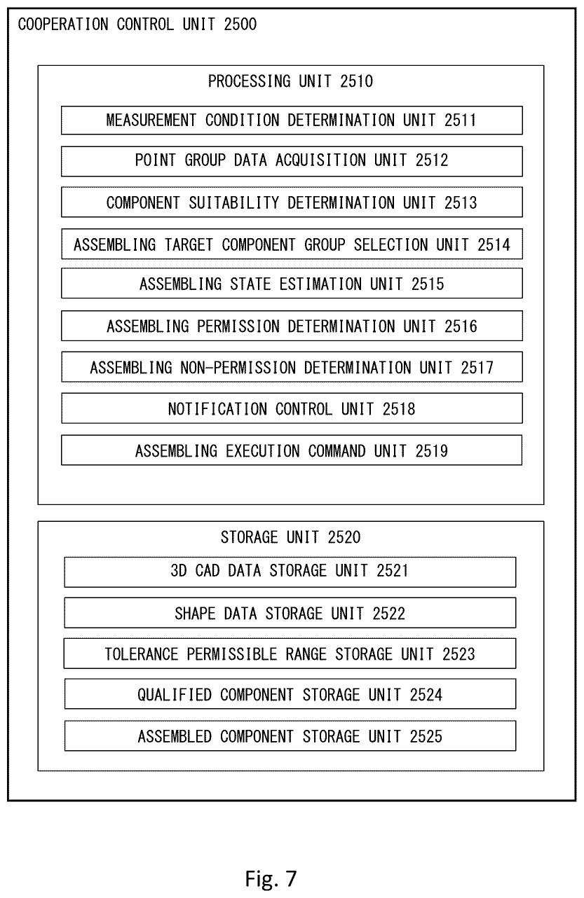

FIG. 7 is a block diagram showing an example of functions implemented in the cooperation control unit 2500. Note that the cooperation control unit 2500 performs one of characteristic processes in the manufacturing system 1000 according to this embodiment. The manufacturing system 1000 according to this embodiment includes at least one measurement sensor 22 that measures the shape of each of a plurality of components of which an assembly is formed, a shape data storage unit 2522 that stores shape data of each of the components acquired by the measurement sensor 22, a assembling target component group selection unit 2514 that selects from among the plurality of components, a first assembling target component group consisting of at least two components, which are components of the assembly, an assembling state estimation unit 2515 that estimates an assembling state of the assembly based on the shape data of the components belonging to the first assembling target component group, and a assembling execution command unit 2519 that provides, to an assembling robot 3000, an assembling execution command for instructing the assembling robot to assemble the assembly using the components included in the first assembling target component group based on a result of the estimation by the assembling state estimation unit 2515.

More specifically, the cooperation control unit 2500 includes a processing unit 2510 and a storage unit 2520. The processing unit 2510 includes a measurement condition determination unit 2511, a point group data acquisition unit 2512, a component suitability determination unit 2513, an assembling target component group selection unit 2514, an assembling state estimation unit 2515, an assembling permission determination unit 2516, an assembling non-permission determination unit 2517, a notification control unit 2518, and an assembling execution command unit 2519. Further, the storage unit 2520 includes a 3D CAD data storage unit 2521, a shape data storage unit 2522, a tolerance permissible range storage unit 2523, a qualified component storage unit 2524, and an assembled component storage unit 2425.

The 3D CAD data storage unit 2521 stores 3D CAD data (3D shape data) which is design data of an object to be measured which is measured by a measuring robot. Further, when the objects to be measured include a plurality of types of components, the 3D CAD data storage unit 2521 stores 3D CAD data (3D shape data) for each of the plurality of types of components.

The measurement condition determination unit 2511 acquires, based on identification information of an object to be measured which a user inputs from the input/output unit 1, 3D CAD data (3D shape data) of the object to be measured corresponding to the identification information from among 3D CAD data of the objects to be measured stored in the 3D CAD data storage unit 2521, determines measurement conditions including the position of the measurement sensor 22 that performs the measurement and the measurement direction (the orientation of the measurement sensor 22) thereof based on the acquired 3D CAD data, and transmits the measurement conditions to the measurement control unit 2400.

The point group data acquisition unit 2512 acquires 3D point group data as the measurement result of the object to be measured from the measurement control unit 2400. Note that when 3D point group data is acquired from a plurality of measurement control units 2400 or acquired from the measurement control unit 2400 a plurality of times, the point group data acquisition unit 2512 generates integrated point group data of the object to be measured by integrating the acquired plurality of 3D point group data. The 3D point group data or integrated point group data acquired by the point group data acquisition unit 2512 is stored in the shape data storage unit 2522.

Information about the tolerance permissible range of the object to be measured is stored in the tolerance permissible range storage unit 2523 in advance. Further, the tolerance permissible range of each of components to be measured (including the first component 41, the second component 42, and the third component), the tolerance permissible range of a primary assembly manufactured by assembling the first component 41 and the second component 42, and the tolerance permissible range of a secondary assembly manufactured by assembling the primary assembly and the third component are also stored in the tolerance permissible range storage unit 2523. A user can input and update the information about tolerance permissible ranges by using the input/output unit 1.

That is, the plurality of components in the manufacturing system 1000 according to this embodiment include a primary assembly formed by assembling the first and second components, and the third component which is assembled to the primary assembly.

The manufacturing system 1000 according to this embodiment includes the component suitability determination unit 2513 that determines, for each component, whether or not a predefined adaptability condition for the component is satisfied based on the shape data thereof, and the assembling target component group selection unit 2514 selects a first assembling target component group from at least two components among a plurality of components each of which is determined to be adaptable by the component suitability determination unit.

The component suitability determination unit 2513 determines whether or not the shape of the object to be measured falls within the tolerance permissible range based on the information about the tolerance permissible range stored in the tolerance permissible range storage unit 2523 and the point group data of the object to be measured acquired by the point group data acquisition unit 2512. Then, when the shape of the object to be measured does not fall within the tolerance permissible range, the component suitability determination unit 2513 determines that the object to be measured does not satisfy the adaptability condition as the component to be assembled. On the other hand, when the shape of the object to be measured falls within the tolerance permissible range, the component suitability determination unit 2513 determines that the object to be measured satisfies the adaptability condition as the component to be assembled. Identification information of the component determined to be appropriate as the component to be assembled is stored in the qualified component storage unit 2524.

The assembling target component group selection unit 2514 selects an assembling target component group which consists of two or more components of the same type or two or more components of a plurality of types, and is a component group for which assembling work is performed. In this embodiment, a primary assembly is manufactured by assembling the first assembling target component group including the first and second components 41 and 42, and then a secondary assembly is manufactured by assembling this primary assembly and the first assembling target component group including the third component 43. Therefore, the assembling target component group selection unit 2514 selects two or more components constituting the first assembling target component group. Further, the assembling target component group selection unit 2514 selects, based on information about a plurality of components each of which is determined to be appropriate as a component to be assembled, stored in the qualified component storage unit 2524, a first assembling target component group from among the plurality of components. By the above-described configuration, it is possible to exclude inappropriate components whose tolerance deviates from the permissible range from the components for which the assembling work is performed on a component-by-component basis.

The assembling state estimation unit 2515 of the manufacturing system 1000 according to this embodiment generates a 3D model of a component based on shape data thereof, simulates the shape of an assembly formed by assembling a first assembling target component group, and thereby estimates the assembling state after the first assembling target component group is assembled.

The assembling state estimation unit 2515 acquires, for each of components corresponding to the first assembling target component group selected by the assembling target component group selection unit 2514, the shape data of the component from the shape data (3D point group data) of the component stored in the shape data storage unit 2522, and estimates the assembling state after the first assembling target component group is assembled based on the shape data. As a more specific example, the assembling state estimation unit 2515 generates a 3D model of each of the components constituting the first assembling target component group selected by the assembling target component group selection unit 2514 based on recorded information stored in the shape data storage unit 2522, simulates the shape of an apparatus (a primary assembly or a secondary assembly, or a product) formed by assembling the first assembling target component group based on the generated 3D model, and estimates the assembling state after the first assembling target component group is assembled. Regarding the shape data (3D point group data) of each of the components stored in the shape data storage unit 2522, it is stored in a such a detailed manner that it is possible to find out an error of the shape of the component that could occurs in the manufacturing process of the component, i.e., the tolerance within the permissible range. Therefore, it is possible to check the detailed shape of the apparatus formed by assembling the first assembling target component group by performing a simulation before the first assembling target component group is actually assembled.

Note that even when it is determined, by the component suitability determination unit 2513, that the shape of the object to be measured is within the tolerance permissible range and hence the object to be measured satisfies the adaptability condition as the component to be assembled, each of the components determined to be adaptable has a shape error within the tolerance range. Therefore, there are cases in which when the first assembling target component group is actually assembled, the shape of the assembled apparatus such as the primary assembly deviates from the tolerance permissible range of the apparatus due to the shape error of each component.

The manufacturing system 1000 according to this embodiment includes the assembling permission determination unit 2516 that determines whether or not the assembling state of the first assembling target component group estimated by the assembling state estimation unit 2515 satisfies a predetermined assembling permission condition. Then, when the assembling permission determination unit 2516 determines that the assembling permission condition is satisfied, the assembling execution command unit 2519 provides an assembling execution command to the assembling robot 3000 for performing work for assembling the first assembling target component group.

Further, the assembling state estimation unit 2515 of the manufacturing system according to the first embodiment generates, based on the shape data of the primary assembly formed by assembling the first and second components included in the first assembling target component group, a 3D model of the primary assembly, generates, based on the shape data of the third component which is assembled to the primary assembly, a 3D model of the third component, and estimates the assembling state of the secondary assembly formed by assembling the third component to the primary assembly by simulating the shape of the secondary assembly using the 3D model of the primary assembly and the 3D model of the third component.

The assembling permission determination unit 2516 determines whether or not the estimated shape data falls within the tolerance permissible range based on the estimated shape data of the apparatus (the primary assembly or the secondary assembly, or the product) after the component is assembled, estimated by the assembling state estimation unit 2515 and the information about the tolerance permissible range of the apparatus stored in the tolerance permissible range storage unit 2523. Then, when the estimated shape data falls within the tolerance permissible range, the assembling permission determination unit 2516 permits the assembling. Note that it is also possible to add a condition other than the condition that the above-described estimated shape data falls within the tolerance permissible range as a condition for permitting the assembling.

The manufacturing system 1000 according to this embodiment includes the assembling non-permission determination unit 2517 that determines whether or not the assembling state of the first assembling target component group estimated by the assembling state estimation unit 2515 satisfies a predetermined assembling non-permission condition. When the assembling non-permission determination unit 2517 determines that the assembling non-permission condition is satisfied, the assembling target component group selection unit 2514 selects a component that satisfies the predetermined assembling permission condition as a second assembling target component group, and the assembling execution command unit 2519 provides, instead of the first assembling target component group, the assembling execution command for instructing the assembling of the assemble using a component included in the second assembling target component group to the assembling robot 3000.

The assembling non-permission determination unit 2517 determines, based on the estimated shape data of the apparatus (the primary assembly or the secondary assembly, or the product) after the assembling of the component, estimated by the assembling state estimation unit 2515 and the information about the tolerance permissible range of the apparatus stored in the tolerance permissible range storage unit 2523, whether or not the estimated shape data is within the tolerance permissible range. Then, when the estimated shape data deviates from the tolerance permissible range, the assembling non-permission determination unit 2517 determines that the assembling is not permitted. Note that it is also possible to add a condition other than the condition that the above-described estimated shape data deviates from the tolerance permissible range as a condition for not permitting the assembling.

The manufacturing system 1000 according to this embodiment includes the notification control unit 2518 that notifies a user of the information for permitting work for assembling the first assembling target component group when the assembling permission determination unit 2516 determines that the assembling permission condition is satisfied.

The notification control unit 2518 notifies the user of the result of the determination by the assembling permission determination unit 2516 or the assembling non-permission determination unit 2517. Specifically, the notification control unit 2518 transmits the result of the determination by the assembling permission determination unit 2516 or the assembling non-permission determination unit 2517 to the input/output unit 1, and thereby notifying the user of the determination result through the output device of the input/output unit 1.

When the assembling permission determination unit 2516 determines that the assembling is permitted, the assembling execution command unit 2519 transmits, to the assembling control unit 2600, an assembling execution command for performing the assembling of the components (e.g., the first assembling target component group or the like) for which the assembling is permitted. Further, information about the combination of the components (e.g., the first assembling target component group or the like) for which the assembling execution command has been issued is stored in the assembled component storage unit 2425.

Note that when the assembling non-permission determination unit 2517 determines that the assembling of the first assembling target component group is not permitted, the assembling target component group selection unit 2514 selects again a combination of components different from the first assembling target component group. The assembling state estimation unit 2515 estimates the assembling state of the re-selected combination of components after the assembling is performed. Then, when the assembling permission determination unit 2516 permits the assembling, the assembling target component group selection unit 2514 selects this combination of components as a second assembling target component group.

The notification control unit 2518 notifies the user of the information about the second assembling target component group re-selected by the assembling target component group selection unit 2514 as described above, and the assembling execution command unit 2519 transmits an assembling execution command for assembling the second assembling target component group to the assembling control unit 2600.

### Function of Assembly Control Unit 2600

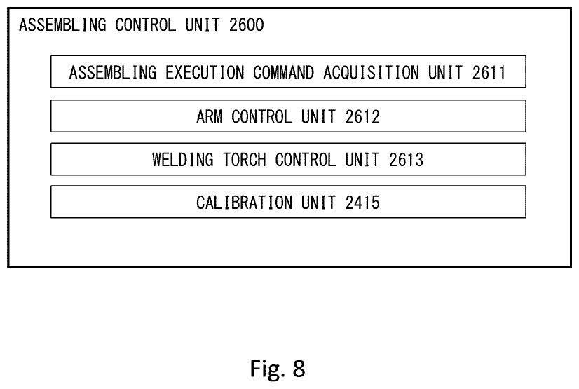

FIG. 8 shows an example of a functional configuration of the assembling control unit 2600. The assembling control unit 2600 includes an assembling execution command acquisition unit 2611, an arm control unit 2612, a welding torch control unit 2613, and a calibration unit 2415. The assembling execution command acquisition unit 2611 receives an assembling execution command for instructing to perform assembling work from the cooperation control unit 2500. The arm control unit 2612 generates an operation command for the arm 31 necessary for the assembling work based on the assembling execution command, transmits the generated operation command to the assembling robot 3000, which is connected to the arm control unit 2612 so that they can communicate with each other, and thereby controls the arm 31 of the assembling robot 3000. Further, the welding torch control unit 2613 generates an operation command for the welding torch 32 necessary for the assembling work based on the assembling execution command, transmits the generated operation command to the welding torch 32 mounted on the assembling robot 3000, which is connected to the welding torch control unit 2613 so that they can communicate with each other, and thereby controls the welding torch 32. The calibration unit 2415 performs a predetermined calibration before performing the assembling work, and associates the robot coordinate system and the torch coordinate system with each other.

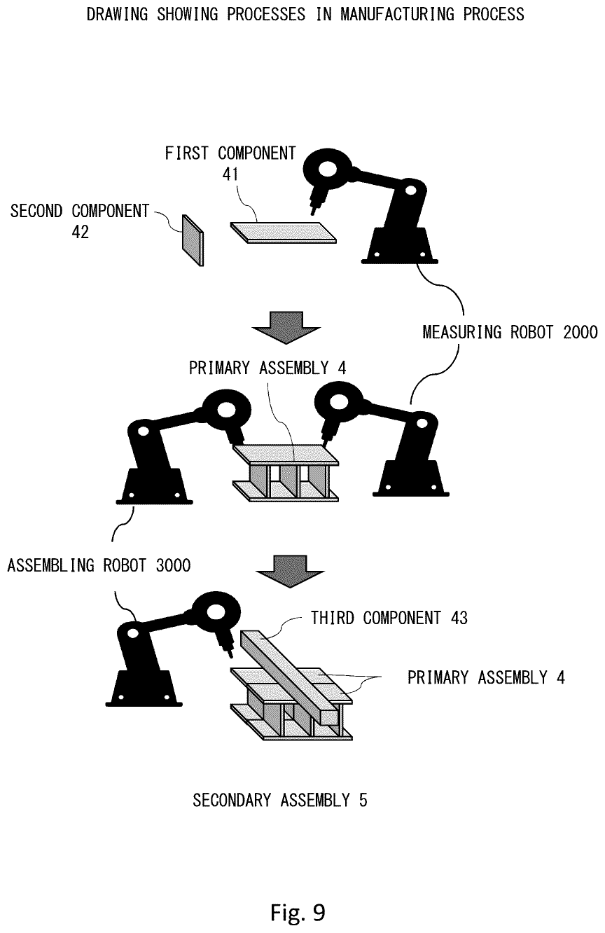

FIG. 9 shows an example of a manufacturing process using a manufacturing system. The example shown in FIG. 9 shows a manufacturing process in which: a primary assembly 4 is manufactured by measuring the shapes of first and second components 41 and 42 by the measuring robot 2000, and assembling the first and second components 41 and 42 by the assembling robot 3000; and then a secondary assembly 5 is manufactured by measuring the shape of the primary assembly 4 by the measuring robot 2000, and assembling the primary assembly 4 and a third component 43 by the assembling robot 3000.

### Processing Flow in Manufacturing of Primary Assembly

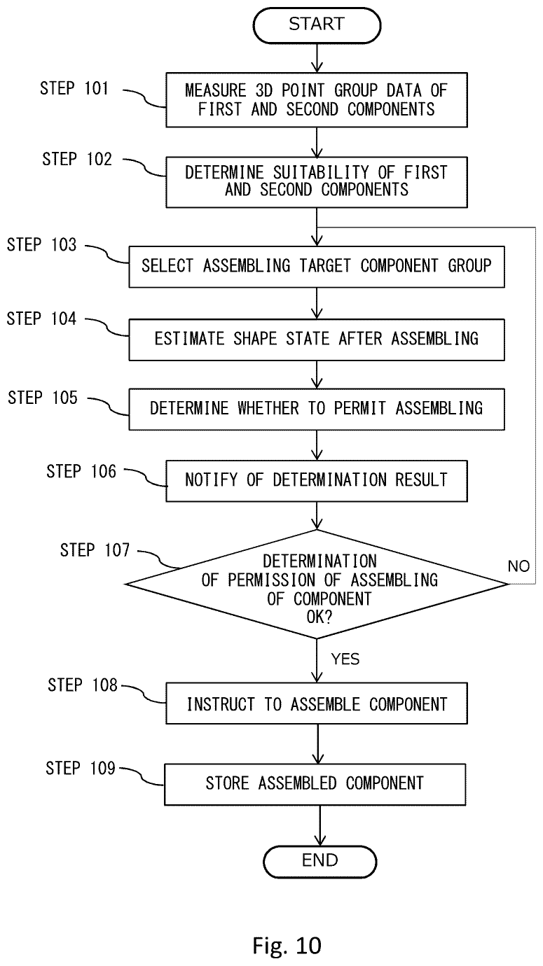

FIG. 10 shows an example of a processing flow when the manufacturing system according to this embodiment manufactures a primary assembly by using first and second components. The operation flow shown in FIG. 10 shows an operation flow when a primary assembly is manufactured by assembling first and second components 41 and 42 in the manufacturing process shown in FIG. 9. Firstly, in a step 101, the measuring robot 2000 measures 3D point group data of the first and second components 41 and 42 to be measured according to the measurement condition determined by the measurement condition determination unit 2511.

Next, in a step 102, it is determined, based on the actually-measured shape data of the first and second components 41 and 42, whether or not the components are suitable based on a determination criterion as to, for example, whether or not the shape error of each of the components falls within the tolerance permissible range.

Next, in a step 103, the assembling target component group selection unit 2514 selects each of first and second components 41 and 42 from among a plurality of components determined to be appropriate in the component suitability determination in the step 102.

Next, in a step 104, the assembling state estimation unit 2515 estimates the after-assembling shape state after the first and second components 41 and 42 are assembled. Specifically, the assembling state estimation unit 2515 generates a 3D model of each of the first and second components 41 and 42 based on the shape data thereof obtained by actually measuring these components, and estimates the shape of a primary assembly formed by assembling the first and second components 41 and 42 by performing a simulation.

Next, in a step 105, the assembling permission determination unit 2516 or the assembling non-permission determination unit 2517 determines whether or not to permit the first and second components 41 and 42 to be assembled based on a predetermined determination criterion such as a criterion as to whether or not the shape of the primary assembly formed by assembling the first and second components 41 and 42 is within a predetermined tolerance permissible range. Next, in a step 106, the result of the determination in the step 105 is notified to the user through the input/output unit 1.

Next, in a step 107, when the result of the assembling permission determination of the first and second components 41 and 42 in the step 105 is “assembling permission”, the process proceeds to a step 108 and an assembling work instruction is issued. On the other hand, when the result of the assembling permission determination of the first and second components 41 and 42 in the step 105 is “assembling non-permission”, the process returns to the step 103 and starts from the selection of an assembling target component group again.

Next, in a step 109, the information about the first and second components 41 and 42, for which the assembling work instruction has been issued in the step 108, is stored in the assembled component storage unit 2425.

### Processing Flow in Manufacturing of Secondary Assembly

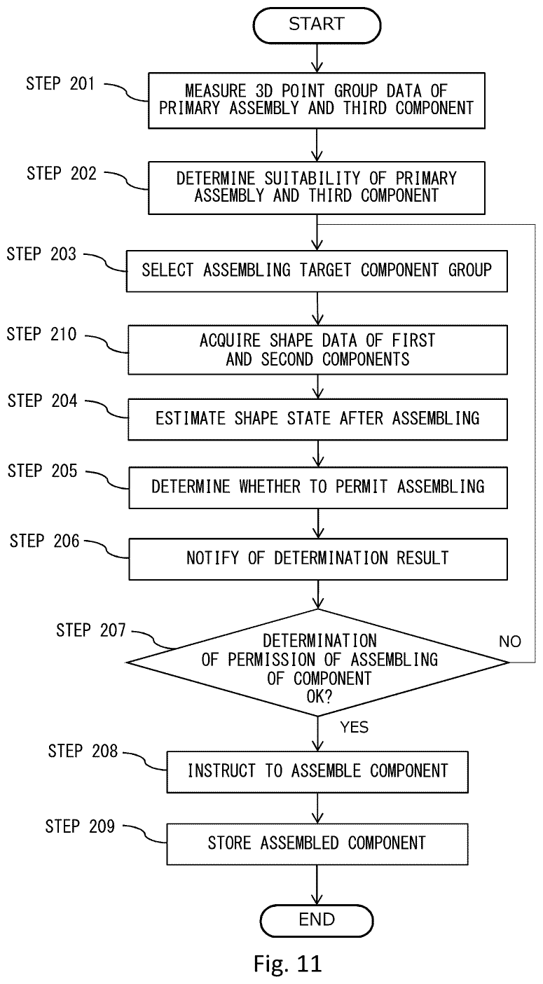

FIG. 11 shows an example of a processing flow when the manufacturing system according to this embodiment manufactures a secondary assembly by using the primary assembly and a third component. Firstly, in a step 201, the measuring robot 2000 measures 3D point group data of the primary assembly and the third component 43, which are components necessary for manufacturing the secondary assembly, according to the measurement condition determined by the measurement condition determination unit 2511.

Next, in a step 202, it is determined, based on the actually-measured shape data of the primary assembly and the third component 43, whether or not the components are adaptable based on a determination criterion as to, for example, whether or not the shape error of each of the components falls within the tolerance permissible range.

Next, in a step 203, the assembling target component group selection unit 2514 selects the primary assembly and the third component 43 from among a plurality of components determined to be appropriate in the component suitability determination in the step 202.

Next, in a step 210, the shape data of the first and second components constituting the primary assembly selected by the assembling target component group selection unit 2514 are acquired from the shape data storage unit 2522.

Next, in a step 204, the assembling state estimation unit 2515 estimates the after-assembling shape state after the primary assembly and the third component 43 are assembled. Specifically, the assembling state estimation unit 2515 generates a 3D model of each of the primary assembly and the third component 43 based on the shape data thereof obtained by actually measuring the primary assembly and the third component 43, and the shape data of the first and second components constituting the primary assembly. Then, the assembling state estimation unit 2515 estimates the shape of a secondary assembly formed by assembling the primary assembly and the third component 43 by performing a simulation.

Note that since the primary assembly has a complicated structure in which the first and second components are assembled with each other. Therefore, when a method in which the primary assembly is measured by a measuring robot in a straightforward manner is used, it is difficult to measure the shape of the inside of the primary assembly and the shape of the contact surface between the first and second components. Therefore, as described above, the assembling state estimation unit 2515 estimates the shape of the secondary assembly by using not only the shape data of each of the primary assembly and the third component 43 obtained by actually measuring them, but also the shape data of each of the first and second components constituting the primary assembly, so that it is possible to estimate the shape of the secondary assembly more accurately and thereby to improve the efficiency of the work for selecting an assembling target component group for manufacturing the secondary assembly.

The subsequent steps 205 to 209 are similar to the steps 105 to 109 shown in FIG. 10, and therefore descriptions thereof will be omitted.

### Supplementary Explanation for Poor Tolerance Matching

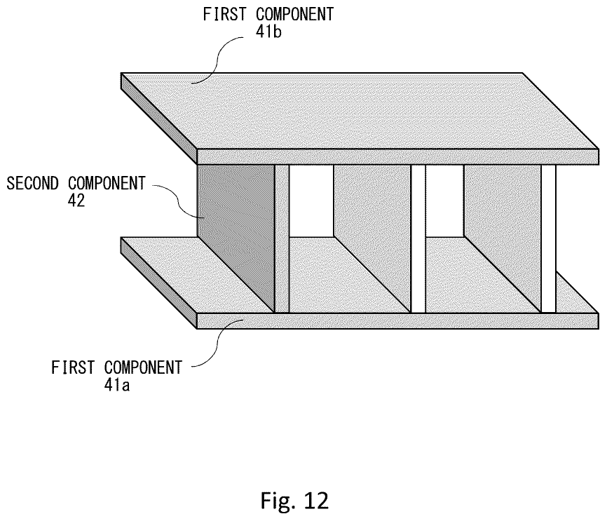

An example in which tolerance matching of components is poor and hence a problem in regard to the shape of the assembled apparatus occurs will be described with reference to FIGS. 12, 13 and 14. FIG. 12 shows an example of a primary assembly manufactured by a manufacturing system. In the example shown in FIG. 12, the primary assembly is composed of two first components (41a and 41b) and three second components 42. One of the two first components located on the lower side of the primary assembly is referred to a first component 41a, and the other first component located on the upper side is referred to a first component 41b.

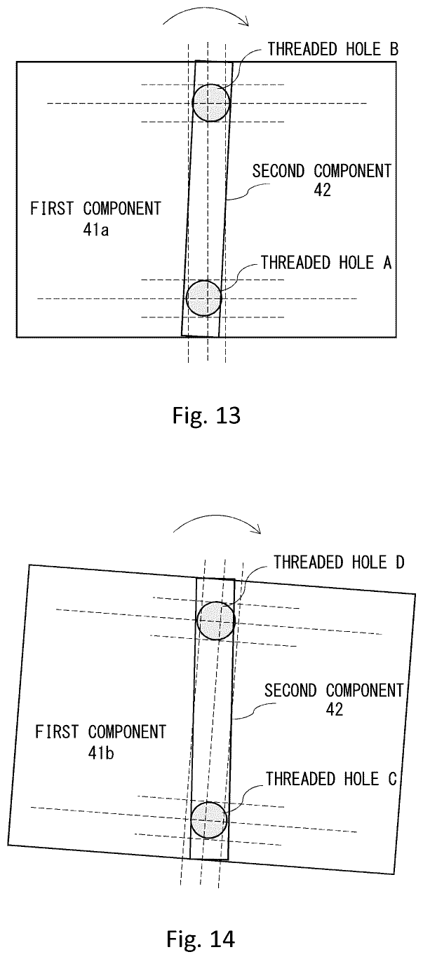

FIGS. 13 and 14 show assembling errors that occur in apparatuses manufactured by the manufacturing system. FIG. 13 shows a screw fastening part between the first component 41a located on the lower side and the second component 42. As shown in FIG. 13, the position of a threaded hole A on the first component 41a deviates to the left from its ideal design position on the 3D CAD data within its tolerance range, and a threaded hole B deviates to the right from its ideal design position on the 3D CAD data within its tolerance range. Therefore, the second component 42 is fixed at a position which is rotated clockwise from the first component 41a.

Further, FIG. 14 shows a screw fastening part between the first component 41b located on the upper side and the second component 42. As shown in FIG. 14, the position of a threaded hole C on the first component 41b deviates to the right from its ideal design position on the 3D CAD data within its tolerance range, and a threaded hole D deviates to the left from its ideal design position on the 3D CAD data within its tolerance range. Therefore, the first component 41b is fixed to a position which is rotated clockwise from the second component 42.

When errors within tolerance ranges as described above occur, the relative positions of the first component 41a and the first component 41b are widely twisted from the ideal design positions and hence deviate from the tolerance permissible range of the primary assembly.

As described above, by estimating the shape and assembling state of the apparatus after the assembling of components to be assembled based on the shape data of each of the components, it is possible to find out in advance that the tolerance matching of the components will be poor and the shape of the apparatus after the assembling will deviate from the predetermined tolerance permissible range of the apparatus before the actual assembling work, and thereby to select components of which the tolerance matching is satisfactory and perform the assembling work using them.

Although the embodiments have been described above, the above-described embodiments are shown just for facilitating the understanding of the present invention and are not intended to limit the scope of the invention. The present invention may be modified or improved without departing from the scope and spirit of the invention, and the present invention includes its equivalents.

This application is based upon and claims the benefits of priorities from Japanese patent applications No. 2022-136035 and No. 2022-136036, both of which were filed on Aug. 29, 2023, the disclosures of which are incorporated herein in their entirety by reference.

Lastly, embodiments according to the present invention will be summarized hereinafter by using drawings and the like. Embodiments according to the present invention are shown as follows based on FIGS. 1 to 14.

### Supplementary Note 1

A manufacturing system comprising:
at least one measurement sensor (22) configured to measure a shape of each of a plurality of components of which an assembly is formed;
a shape data storage unit (2522) configured to store shape data of each of the components acquired by the measurement sensor (22);
an assembling target component group selection unit (2514) configured to select, from among the plurality of components, a first assembling target component group including at least two components, the at least two components being components of the assembly;
an assembling state estimation unit (2515) configured to estimate an assembling state of the assembly based on the shape data of the components belonging to the first assembling target component group; and
an assembling execution command unit (2519) configured to provide, to an assembling robot (3000), an assembling execution command for instructing the assembling robot (3000) to assemble the assembly using the components included in the first assembling target component group based on a result of the estimation by the assembling state estimation unit (2515).

### Supplementary Note 2

The manufacturing system described in Supplementary note 1, wherein the plurality of components include a primary assembly formed by assembling a first component and a second component, and a third component to be assembled to the primary assembly.

### Supplementary Note 3

The manufacturing system described in Supplementary note 1 or 2, further comprising an assembling permission determination unit (2516) configured to determine whether or not the assembling state of the first assembling target component group estimated by the assembling state estimation unit (2515) satisfies a predetermined assembling permission condition, wherein
when the assembling permission determination unit (2516) determines that the assembling permission condition is satisfied, the assembling execution command unit (2519) provides the assembling execution command for performing work for assembling the first assembling target component group to the assembling robot (3000).

### Supplementary Note 4

The manufacturing system described in any one of Supplementary notes 1 to 3, further comprising an assembling non-permission determination unit (2517) configured to determine whether or not the assembling state of the first assembling target component group estimated by the assembling state estimation unit (2515) satisfies a predetermined assembling non-permission condition, wherein
when the assembling non-permission determination unit (2517) determines that the assembling non-permission condition is satisfied, the assembling target component group selection unit (2514) selects the component that satisfies the predetermined assembling permission condition as a second assembling target component group, and
the assembling execution command unit (2519) provides, instead of the first assembling target component group, the assembling execution command for instructing to perform the assembling of the assembly using the component included in the second assembling target component group to the assembling robot (3000).

### Supplementary Note 5

The manufacturing system described in any one of Supplementary notes 1 to 4, wherein the assembling state estimation unit (2515):
generates a 3D model of the component based on the shape data thereof; and
estimates an assembling state after the first assembling target component group is assembled by simulating a shape of the assembly formed by assembling the first assembling target component group.

### Supplementary Note 6

The manufacturing system described in Supplementary note 5, wherein
the assembling state estimation unit (2515):
generates a 3D model of a primary assembly formed by assembling a first component and a second component included in the first assembling target component group based on shape data of the primary assembly;
generates a 3D model of a third component to be assembled to the primary assembly based on shape data of the third component; and
estimates an assembling state of a secondary assembly obtained by assembling the third component to the primary assembly by simulating the shape of the secondary assembly using the 3D model of the primary assembly and the 3D model of the third component.

### Supplementary Note 7

The manufacturing system described in any one of Supplementary notes 1 to 6, further comprising a component suitability determination unit (2513) configured to determine whether or not each of the components satisfies a predefined adaptability condition of the component based on the shape data thereof, wherein
the assembling target component group selection unit (2514) selects the first assembling target component group from among at least two components among the plurality of components determined to be adaptable by the component suitability determination unit.

### Supplementary Note 8

The manufacturing system described in Supplementary note 3, further comprising a notification control unit (2518) configured to notify a user of permission information of work for assembling the first assembling target component group when the assembling permission determination unit (2516) determines that the assembling permission condition is satisfied.

### Supplementary Note 9

The manufacturing system described in any one of Supplementary notes 1 to 8, further comprising an assembling robot (3000) configured to perform work for assembling the first assembling target component group according to the assembling execution command output from the assembling execution command unit (2519).

### Supplementary Note 10

A method for controlling a manufacturing system configured to manufacture an assembly by assembling a plurality of components by using an assembling robot (3000), wherein a computer performs processes including:
acquiring, for each of a plurality of components of which the assembly is formed, shape data of the component from a result of measurement of a shape of the component (101);
storing the shape data of each of the components in a shape data storage unit (101);
selecting, from among the plurality of components, a first assembling target component group including at least two components, the at least two components being components of the assembly (103);
estimating an assembling state of the assembly based on the shape data of the components belonging to the first assembling target component group (104); and
providing, to an assembling robot (3000), an assembling execution command for instructing the assembling robot (3000) to assemble the assembly using the components included in the first assembling target component group based on a result of the estimation (108).

### Supplementary Note 11

A control program for causing a computer to perform processes including:
a shape data acquisition process for acquiring, for each of a plurality of components of which the assembly is formed, shape data of the component from a result of measurement of a shape of the component (101);
a shape data storing process for storing the shape data of each of the components in a shape data storage unit (101);
an assembling target component group selecting process for selecting, from among the plurality of components, a first assembling target component group including at least two components, the at least two components being components of the assembly (103);
an assembling state estimation process for estimating an assembling state of the assembly based on the shape data of the components belonging to the first assembling target component group (104); and
an assembling execution command for providing, to an assembling robot (3000), an assembling execution command for instructing the assembling robot (3000) to assemble the assembly using the components included in the first assembling target component group based on a result of the estimation (108).

### REFERENCE SIGNS LIST

1: INPUT/OUTPUT UNIT, 2: CONTROLLER, 4: PRIMARY ASSEMBLY, 10: PROCESSOR, 11: MEMORY, 12: STORAGE, 13: TRANSMITTING/RECEIVING UNIT, 15: BUS, 21: ARM, 22: MEASUREMENT SENSOR, 23: WELDING TORCH, 31: FIRST COMPONENT, 32: WELDING TORCH, 41: FIRST COMPONENT, 42: SECOND COMPONENT, 43: THIRD COMPONENT, 1000: MANUFACTURING SYSTEM, 2000: MEASURING ROBOT, 2400: MEASUREMENT CONTROL UNIT, 2411: MEASUREMENT CONDITION ACQUISITION UNIT, 2412: ARM CONTROL UNIT, 2413: MEASUREMENT SENSOR CONTROL UNIT, 2414: MEASUREMENT DATA ACQUISITION UNIT, 2415: CALIBRATION UNIT, 2500: COOPERATION CONTROL UNIT, 2510: PROCESSING UNIT, 2511: MEASUREMENT CONDITION DETERMINATION UNIT, 2512: POINT GROUP DATA ACQUISITION UNIT, 2513: COMPONENT SUITABILITY DETERMINATION UNIT, 2514: ASSEMBLING TARGET COMPONENT GROUP SELECTION UNIT, 2515: ASSEMBLING STATE ESTIMATION UNIT, 2516: ASSEMBLING PERMISSION DETERMINATION UNIT, 2517: ASSEMBLING NON-PERMISSION DETERMINATION UNIT, 2518: NOTIFICATION CONTROL UNIT, 2519: ASSEMBLING EXECUTION COMMAND UNIT, 2520: STORAGE UNIT, 2521: 3D CAD DATA STORAGE UNIT, 2522: SHAPE DATA STORAGE UNIT, 2523: TOLERANCE PERMISSIBLE RANGE STORAGE UNIT, 2524: QUALIFIED COMPONENT STORAGE UNIT, 2425: ASSEMBLED COMPONENT STORAGE UNIT, 2600: ASSEMBLING CONTROL UNIT, 2611: ASSEMBLING EXECUTION COMMAND ACQUISITION UNIT, 2612: ARM CONTROL UNIT, 2613: WELDING TORCH CONTROL UNIT, 3000: ASSEMBLING ROBOT

1. A manufacturing system comprising:
at least one measurement sensor configured to measure a shape of each of a plurality of components of which an assembly is formed;
a shape data storage unit configured to store shape data of each of the components acquired by the measurement sensor;
an assembling target component group selection unit configured to select, from among the plurality of components, a first assembling target component group including at least two components, the at least two components being components of the assembly;
an assembling state estimation unit configured to estimate an assembling state of the assembly based on the shape data of the components belonging to the first assembling target component group; and
an assembling execution command unit configured to provide, to an assembling robot, an assembling execution command for instructing the assembling robot to assemble the assembly using the components included in the first assembling target component group based on a result of the estimation by the assembling state estimation unit.

2. The manufacturing system according to claim 1, wherein the plurality of components include a primary assembly formed by assembling a first component and a second component, and a third component to be assembled to the primary assembly.

3. The manufacturing system according to claim 1, further comprising an assembling permission determination unit configured to determine whether or not the assembling state of the first assembling target component group estimated by the assembling state estimation unit satisfies a predetermined assembling permission condition, wherein
when the assembling permission determination unit determines that the assembling permission condition is satisfied, the assembling execution command unit provides the assembling execution command for performing work for assembling the first assembling target component group to the assembling robot.

4. The manufacturing system according to claim 1, further comprising an assembling non-permission determination unit configured to determine whether or not the assembling state of the first assembling target component group estimated by the assembling state estimation unit satisfies a predetermined assembling non-permission condition, wherein
when the assembling non-permission determination unit determines that the assembling non-permission condition is satisfied, the assembling target component group selection unit selects the component that satisfies the predetermined assembling permission condition as a second assembling target component group, and
the assembling execution command unit provides, instead of the first assembling target component group, the assembling execution command for instructing to perform the assembling of the assembly using the component included in the second assembling target component group to the assembling robot.

5. The manufacturing system according to claim 1, wherein the assembling state estimation unit:
generates a 3D model of the component based on the shape data thereof; and
estimates an assembling state after the first assembling target component group is assembled by simulating a shape of the assembly formed by assembling the first assembling target component group.

6. The manufacturing system according to claim 5, wherein
the assembling state estimation unit:
generates a 3D model of a primary assembly formed by assembling a first component and a second component included in the first assembling target component group based on shape data of the primary assembly;
generates a 3D model of a third component to be assembled to the primary assembly based on shape data of the third component; and
estimates an assembling state of a secondary assembly obtained by assembling the third component to the primary assembly by simulating the shape of the secondary assembly using the 3D model of the primary assembly and the 3D model of the third component.

7. The manufacturing system according to claim 1, further comprising a component suitability determination unit configured to determine whether or not each of the components satisfies a predefined adaptability condition of the component based on the shape data thereof, wherein
the assembling target component group selection unit selects the first assembling target component group from among at least two components among the plurality of components determined to be adaptable by the component suitability determination unit.

8. The manufacturing system according to claim 3, further comprising a notification control unit configured to notify a user of permission information of work for assembling the first assembling target component group when the assembling permission determination unit determines that the assembling permission condition is satisfied.

9. The manufacturing system according to claim 1, further comprising an assembling robot configured to perform work for assembling the first assembling target component group according to the assembling execution command output from the assembling execution command unit.

10. A method for controlling a manufacturing system configured to manufacture an assembly by assembling a plurality of components by using an assembling robot, wherein a computer performs processes including:
acquiring, for each of a plurality of components of which the assembly is formed, shape data of the component from a result of measurement of a shape of the component;
storing the shape data of each of the components in a shape data storage unit;
selecting, from among the plurality of components, a first assembling target component group including at least two components, the at least two components being components of the assembly;
estimating an assembling state of the assembly based on the shape data of the components belonging to the first assembling target component group; and
providing, to an assembling robot, an assembling execution command for instructing the assembling robot to assemble the assembly using the components included in the first assembling target component group based on a result of the estimation.

11. A computer-readable medium storing a control program for causing a computer to perform processes including:
a shape data acquisition process for acquiring, for each of a plurality of components of which the assembly is formed, shape data of the component from a result of measurement of a shape of the component;
a shape data storing process for storing the shape data of each of the components in a shape data storage unit;
an assembling target component group selecting process for selecting, from among the plurality of components, a first assembling target component group including at least two components, the at least two components being components of the assembly;
an assembling state estimation process for estimating an assembling state of the assembly based on the shape data of the components belonging to the first assembling target component group; and
an assembling execution command for providing, to an assembling robot, an assembling execution command for instructing the assembling robot to assemble the assembly using the components included in the first assembling target component group based on a result of the estimation.
